(19) United States
(12) Patent Application Publication
(10) Pub. No.: US 2017/0154000 A1
(43) Pub. Date: Jun. 1, 2017

(54) Dynamic Re-Allocation of Computer Bus Lanes

(71) Applicant: International Business Machines Corporation, Armonk, NY (US)

(72) Inventors: Victor A. Garibay, Leander, TX (US); Daniel E. Hurlimann, Austin, TX (US); Chetan Mehta, Austin, TX (US); Fernando Pizzano, Poughkeepsie, NY (US); Thomas R. Sand, Rochester, MN (US)

(73) Assignee: International Business Machines Corporation, Armonk, NY (US)

(21) Appl. No.: 14/955,805

(22) Filed: Dec. 1, 2015

(51) Int. Cl. G06F 13/40; G06F 13/38; G06F 13/42; G06F 13/16

(52) U.S. Cl. CPC G06F 13/4022; G06F 13/1678; G06F 13/385; G06F 13/4221

(57) ABSTRACT

The embodiments relate to dynamically re-allocating lanes of a computer bus. A computer system is configured with a plurality of connectors in communication with a module, with each connector configured to receive a respective adapter. The module detects a presence of each adapter and controls an initial allocation of lanes to each detected adapter for maximizing adapter functionality. After the initial allocation and in response to performance evaluation, the module dynamically switches lanes from the among the adapters, including allocation of available lane, upshifting lane allocation to one or more adapters, and/or downshifting lane allocation to one or more adapters.

### BACKGROUND

The embodiments described herein relate generally to allocation of lanes to a computer bus. More specifically, the embodiments described herein relate to adapter performance evaluation and allocation or re-allocation of lanes based on the evaluation.

In computer architecture, a bus is a communication system that transfers data between components of a computer system. A local input/output (I/O) bus transfers data between a peripheral component and a computing device. Various types of I/O buses include, but are not limited to, Peripheral Components Interconnect (PCI), Accelerated Graphics Port (AGP), Industry Standard Architecture (ISA), Universal Serial Bus (USB), Micro Channel Architecture (MCA), Enhanced ISA (EISA), Video Electronics Standards Association (VESA), etc.

A PCI Express (PCI-e) bus is an implementation of a PCI computer bus according to a set of PCI Express specifications promulgated by the PCI Special Interest Group. The PCI-e bus uses conventional PCI programming and software concepts, but is based on serial bus architecture as opposed to the parallel bus architecture of the conventional PCI. This physical-layer of the PCI-e computer bus consists of a network of serial interconnections extending from a PCI host bridge or a switch to each peripheral component, referred to herein as an adapter. A connection between the host bridge or the switch to an adapter is referred to as a “link.” The link consists of a collection of one or more lanes used for data communications. Each lane is a set of two unidirectional low voltage differential signaling pairs of transmission pathways such as, for example, traces along a motherboard. Since transmitting data and receiving data are implemented using separate differential pairs, each lane allows for full-duplex serial data communication.

Adapters minimally support single-lane links, and may optionally support wider links composed of two (×2), four (×4), eight (×8), twelve (×12), sixteen (×16), or thirty-two lanes (×32) by providing additional pins on the hardware interface of the adapter that plugs into a PCI-e connector, hereinafter referred to as a connector. The connector may physically support connections for one (×1), two (×2), four (×4), eight (×8), twelve (×12), sixteen (×16), or thirty-two (×32) lanes. Each adapter may be received by any connector that physically supports the same or a greater number of lanes as the lanes physically supported by the adapter. For example an adapter (×8) may be installed into any connector (×8)-(×32). Although the connector and its installed adapter may physically support links with up to thirty-two lanes, an adapter may utilize fewer lanes for data communication than the maximum number of lanes physically supported by the adapter and the connector. For example, for an adapter (×8) installed in a connector (×16), the adapter (×8) may utilize one, two, or four of those eight lanes for data communications. The number of lanes actually utilized for the data communications link between the PCI host bridge or switch and an adapter is typically the highest number of lanes mutually supported by the host bridge, the adapter and its corresponding connector.

### SUMMARY

The aspects described herein include a system, a method, and a computer program product for dynamically re-allocating lanes among connectors of a computer bus.

According to one aspect, a system is provided to support dynamic re-allocation of lanes of a computer bus interface. The system includes a processor in communication with memory and a module. A plurality of connectors is in communication with the module, with each connector configured to receive a respective adapter. The module detects presence of each adapter present at boot-time and dynamically controls lane allocation to the connectors having a detected adapter. Following the initial allocation, performance of the adapters is evaluated, and a dynamic re-allocation of lanes may take place to improve system performance.

According to another aspect, a method is provided for dynamically re-allocating lanes of a computer bus interface. The method includes configuring a computer system with a plurality of connectors in communication with a module, with each connector configured to receive a respective adapter. The module detects a presence of each adapter, and controls an initial allocation of lanes to each detected primary adapter. The initial allocation maximizes adapter functionality. After the initial allocation system performance is evaluated, and based on evaluation the module may dynamically re-allocate lanes to improve system performance.

According to yet another aspect, a computer program product is provided to dynamically re-allocate lanes of a computer bus interface. The computer program product includes a computer-readable storage medium having program code embodied therewith. The program code is executable by a processing unit to configure a computer system with a plurality of connectors in communication with a module, with each connector configured to receive a respective adapter. Presence of each adapter is detected, and an initial allocation of lanes to each detected adapter is controlled. The initial allocation maximizes adapter functionality. After the initial allocation and in response to performance evaluation of the system based on the allocation, one or more lanes may be dynamically re-allocated to improve system performance.

Other features and advantages of this invention will become apparent from the following detailed description of the presently preferred embodiment(s), taken in conjunction with the accompanying drawings.

### BRIEF DESCRIPTION OF THE SEVERAL VIEWS OF THE DRAWINGS

The drawings referenced herein form a part of the specification. Features shown in the drawings are meant as illustrative of only some embodiments, and not all embodiments, unless otherwise explicitly indicated.

FIG. 1 depicts a block diagram illustrating an example of a computer bus interface system to support adapter redundancy and associated lane allocation.

FIG. 2 depicts a flow chart illustrating a process for performance driven lane reassignment.

FIG. 3 depicts a flow chart illustrating a process for modifying lane allocation among adapters being driven by input from an administrator.

FIG. 4 depicts a block diagram illustrating an example of a computer system to implement the processes shown in FIGS. 1-3.

FIG. 5 depicts a chart illustrating an allocation of lanes, in accordance with an exemplary embodiment.

FIG. 6 depicts a chart illustrating a dynamic re-allocation of lanes in accordance with an exemplary embodiment.

### DETAILED DESCRIPTION

It will be readily understood that the components of the embodiments described herein, as generally described and illustrated in the Figures herein, may be arranged and designed in a wide variety of different configurations. Thus, the following detailed description of the embodiments of the method, computer program product, and system, as presented in the Figures, is not intended to be limited, as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiment. Thus, appearances of the phrases “a select embodiment,” “in one embodiment,” or “in an embodiment” in various places throughout this specification are not necessarily referring to the same embodiment.

The illustrated embodiments described herein will be best understood by reference to the drawings, wherein like parts are designated by like numerals throughout. The following description is intended only by way of example, and simply illustrates certain selected embodiments of devices, systems, and processes that are consistent with the claims herein.

Allocation of lanes to connectors having installed, or received, adapters may be fixed at boot-time, or power-up time. That is, whichever configuration is picked at the system start, e.g. boot, will be the configuration that the computer system will have during operation. Other approaches for lane allocation include detecting the presence of each received adapter at boot-time, and allocating lanes based on the detection. It is understood that performance and/or usage of a connector and an associated adapter may change after an initial program load (IPL), and that a lane-allocation may not be appropriately allocated based on the change. Accordingly, a dynamic reconfiguration of lane assignments among adapters and associated connectors is supported to enhance system performance.

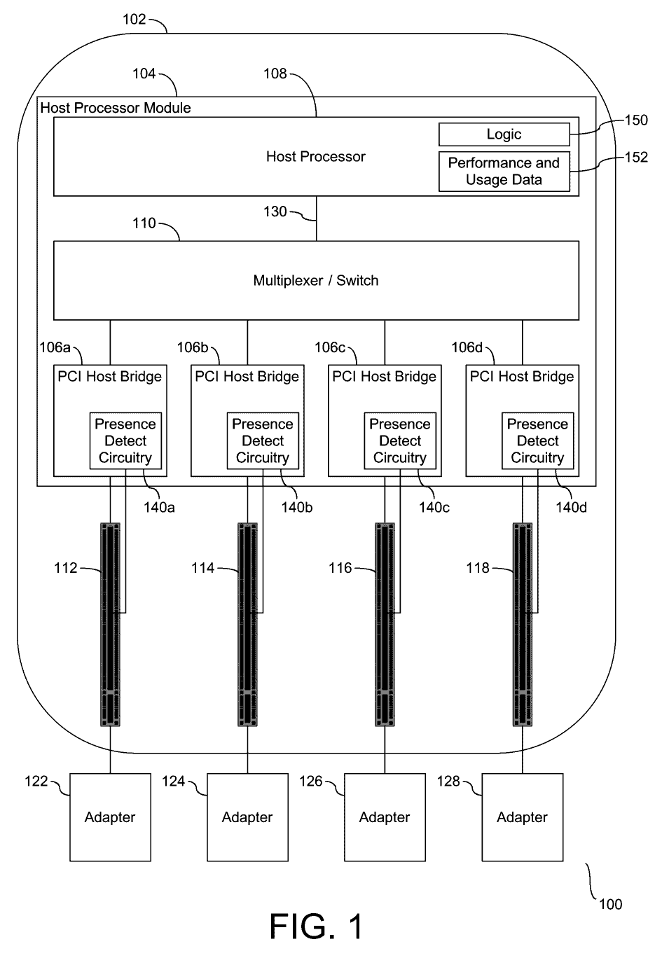

Server resiliency is a high priority to ensure hosted applications remain functional and operating. One aspect to address continued application operation and processing is to design redundancy into the server. With reference to FIG. 1, a block diagram (100) is provided illustrating an example of a computer bus interface system (102) to support adapter redundancy and associated lane allocation. The system (102) is operational with numerous other general purpose or special purpose computing system environments or configurations. Examples of well-known computing systems, environments, and/or configurations that may be suitable for use with the system (102) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

As shown in FIG. 1, the system (102) includes a host processor module (104). The module (104) is further shown having four host bridges (106a), (106b), (106c), and (106d). In alternative embodiments, the quantity of host bridges may be different depending on the computer bus interface system being utilized and, as such, it is to be understood and appreciated that the embodiments described herein are not limited to the four host bridges (106a)-(106d).

The module (104) further includes a host processor (108) in communication with a multiplexer or other switch (“MUX/switch”) (110). The MUX/switch (110) is also in communication with each of the host bridges (106a)-(106d). The MUX/switch (110) provides communication between the host processor (108) and each host bridge (106a)-(106d). A plurality of connectors (112)-(118) of the system (102) is shown. Although only four connectors are shown, this quantity is not considered limiting. Each connector (112), (114), (116), and (118) is shown in communication with the module (104) via host bridges (106a), (106b), (106c), and (106d), respectively. In alternative embodiments, the quantity of connectors may be different depending on the computer bus interface system being utilized and, as such, it is to be understood and appreciated that the embodiments described herein are not limited to the four connectors (112)-(118) as shown. As shown, each connector is in communication with a respective host bridge, with a direct correspondence between each host bridge and each associated connector.

It is to be understood that the modular arrangement of the components described herein above is provided as an illustrative example, and it is to be appreciated that the components may be arranged in any configuration in accordance with the embodiments described herein. In other words, the term “module” as used herein should not be interpreted to be limiting with respect to the particular arrangement described above, but should be broadly construed to include any combination of the components. For example, the components may be arranged in a single hardware device, as a combination of multiple hardware devices, or in any combination thereof in accordance with the embodiments described herein.

Each connector (112)-(118) is configured to receive a respective maximum number of lanes for allocation, which may be referred to as a connector width. In one embodiment, each connector (112)-(118) may be a 16 lane PCI-e connector, which means that each connector (112)-(118) has a 16-lane width. Hence, a maximum of sixty-four lanes may (theoretically) be allocated among the connectors shown (i.e., 16×4=64). In the system (102), there are a finite number of total lanes (130) that may be allocated among the connectors (112)-(118). In the embodiment shown and described in FIG. 1, forty total lanes (130) are available for allocation. Accordingly, in this example, there are fewer lanes available for allocation than the maximum number of lanes that may be allocated to each connector, respectively.

Since each of the connectors (112)-(118) has a 16-lane width, any adapter received by the connectors (112)-(118) may not have a lane designation exceeding sixteen lanes, but may have a lane designation less than sixteen lanes. For example, in the embodiment shown and described in FIG. 1, between four and sixteen of the available lanes (130), inclusive, may be allocated among each connector (112)-(118), respectively. In one embodiment, each adapter may have a different lane designation and, as such, it is to be understood and appreciated that the adapters may have varying lane designations.

Presence detect circuitry (140a), (140b), (140c), and (140d), hereinafter referred to as detectors (140a)-(140d), are shown embedded in host bridges (106a), (106b), (106c), and (106d), respectively, and in communication with the connectors (112), (114), (116), and (118), respectively. The detectors (140a)-(140d) are configured to detect the adapters present at IPL, also referred to herein as boot-time

At boot-time, as shown in this example, adapters (122), (124), (126), and (128) are received by connectors (112), (114), (116), and (118), respectively. Detectors (140a)-(140d) detect the presence of adapters (122)-(128) received by their respective connectors (112)-(118). The host processor (102) is configured with logic (150) to collect adapter performance and usage data (152), and to periodically perform an assessment of the lane allocation based on the collected data (152). In response to a performance assessment, the logic (150) may employ the MUX/switch (110) to re-configure the lane assignments, which in one embodiment will enhance performance of a subsequent workload. For example, in one embodiment, the logic (150) may employ the MUX/switch (110) to dynamically assign more lanes to one or more busy adapters and fewer lanes to adapters that have a smaller workload, or a smaller projected workload. Accordingly, the logic (150) functions to assess performance with respect to lane allocation and to communicate with the MUX/switch (150) to dynamically allocate or re-allocate lane assignment based on the assessed performance, and in one embodiment based on a projected workload.

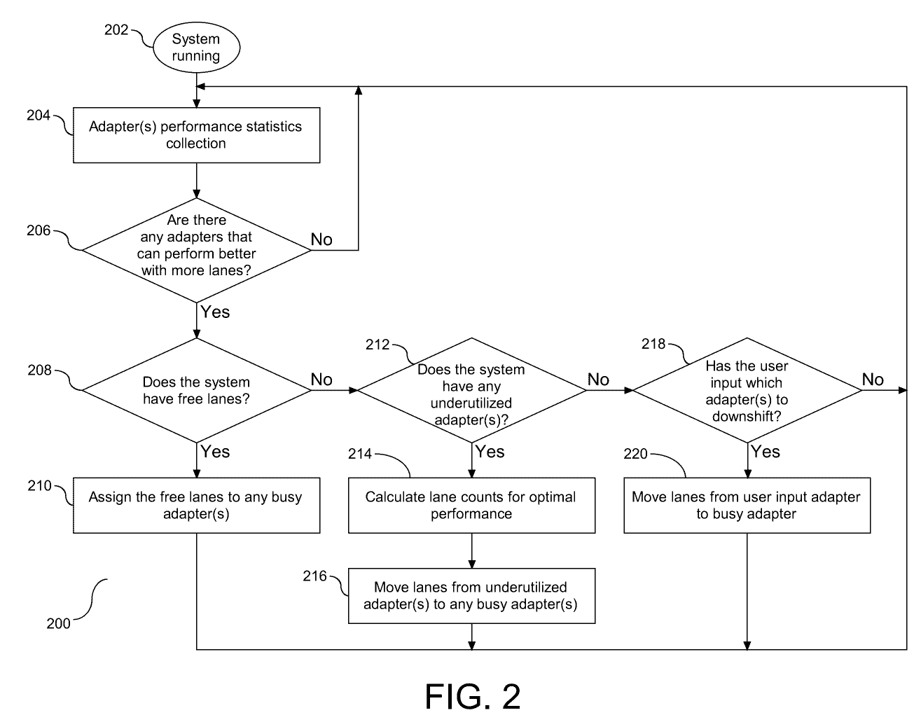

Referring now to FIG. 2, a flow chart (200) is provided illustrating a process for performance driven lane re-assignment. As shown, the system is configured with a set of adapters and associated lane assignment(s) (202). During operation, adapter performance statistics are collected to predict future performance based on lane allocation (204). For example, in one embodiment, a first adapter may be owned by a first partition and operating in one region of the world, and a second adapter may be owned by a second partition and operating in a second region of the world. In one embodiment, a partition is an operating system or an operating system instance. The statistics gathered at step (204) would demonstrate the operating behavior of the associated adapters that reflect different time zones. More specifically, the first adapter may be under-utilized concurrent with over-utilization of the second adapter. The statistics gathered at step (204) would demonstrate this difference and/or additional patterns associated with usage metrics.

More specifically, step (204) represents an oversight of adapter performance and/or usage. Following the data collection at step (204), it is determined if the system has any adapters that can or would perform better if more lanes were allocated (206). A positive response to the determination at step (206) is followed by determining if the system has any available lanes, i.e. any lanes that are not currently allocated to an adapter, (208). A positive response to the determination at step (208) is following by an assignment of one or more of the available lanes to the under-utilized adapters (210). In one embodiment, there is a plurality of under-utilized adapters, and the lanes are distributed among the adapters. Following the allocation of the available lanes, the process returns to step (204) to gather the adapter performance data based on the lane allocation. Similarly, a negative response to the determination step (206) is an indication that the current lane allocation is appropriate or proportional, and the process returns to step (204) to continue gathering adapter performance data. Accordingly, available lanes may be allocated to one or more adapters assessed as under-utilized.

However, a negative response to the determination at step (208) is followed by assessing under-utilization of any of the adapters (212). More specifically, one or more of the adapters may have been assigned with more lanes than required to efficiently operate and support the associated connector. If any of the adapters are identified as under-utilized during the assessment at step (212), a lane count for optimal performance of each under-utilized adapter is calculated (214). Excess lanes from one or more of these adapters, e.g. lanes in excess of the lane count, are moved to the one or more adapters that require or would benefit from an additional lane assignment (216), followed by a return to step (204) to continue gathering adapter performance data based on the new lane allocation. Accordingly, excess lanes from one or more over-utilized adapters may be transferred to one or more under-utilized adapters.

A negative response to the determination at step (212) is an indication that the system is not configured with under-utilized adapters. As such, it is then determined if the operating system or administrator has designated any of the adapters available for a lane downshift, e.g. lane allocation may be decreased, (218). In one embodiment, the lane downshift is an autonomous link width downsizing, wherein one side of the link can downsize the width and the other side complies with the width change. A negative response to the determination at step (218) is an indication that the adapters and the associated lane allocation will remain unchanged, as shown by a return to step (204). However, a positive response to the determination at step (218) is followed by moving lanes from an adapter designated for a lane downshift to an adapter designated for an allocation increase, e.g. lane upshift, (220). In one embodiment, the lane upshift is an autonomous reconfiguration of the lane width. Accordingly, adapter performance may be utilized as a factor for lane allocation of available lanes, or re-allocation employing adapter upshift and downshift.

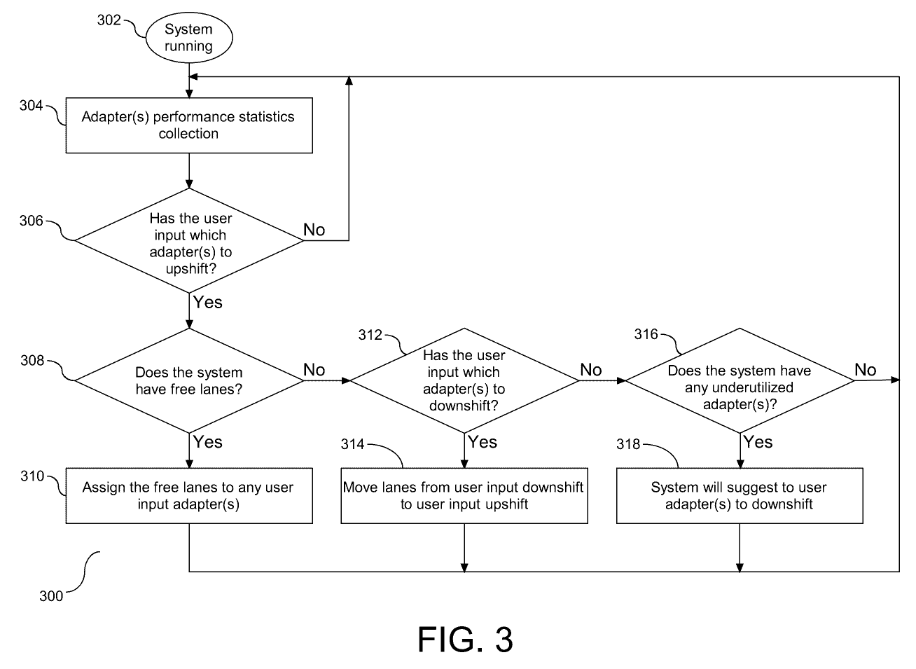

Adapters may be subject to a lane allocation change in the form of an upshift, also referred to herein as a lane allocation increase, and a downshift, also referred to herein as a lane allocation decrease. As shown in FIG. 2, the lane allocation change may be based on performance statistics and/or evaluation. Referring to FIG. 3, a flow chart (300) is provided illustrating a process for modifying lane allocation among adapters being driven by input from an administrator. As shown, the system is configured with a set of adapters and associated lane assignment(s) (302). During operation, adapter performance statistics are collected (304). For example, in one embodiment a first adapter may be owned by a first partition and operating in one region of the world, and a second adapter may be owned by a second partition and operating in a second region of the world. The statistics gathered at step (304) would demonstrate the operating behavior of the associate adapters that reflect different time zones. More specifically, the first adapter may be under-utilized concurrent with over-utilization of the second adapter. The statistics gathered at step (304) would demonstrate this difference and/or additional patterns associated with usage metrics. Administrator driven control for lane shifting may be pre-defined, or in one embodiment, may be in the form of a program that allows parameters to be shifted.

Regardless of the form of control, following step (304), it is determined if the system has defined input designated one or more adapters for a lane upshift (306). A positive response to the determination at step (306) is followed by determining if the system has any available lanes, i.e. any lanes that are not currently allocated to an adapter (308). A positive response to the determination at step (308) is following by an assignment of one or more of the available lanes to the adapters designated for upshift (310). In one embodiment, there is a plurality of adapters designated for upshift and the lanes are distributed among these designated adapters. Following the allocation of the available lanes at step (310), the process returns to step (304) to gather the adapter performance data based on the lane allocation. Similarly, a negative response to the determination step (306) is an indication that the current lane allocation is appropriate or proportional, and the process returns to step (304) to continue gathering adapter performance data. Accordingly, available lanes may be allocated to one or more adapters designated for upshift.

However, a negative response to the determination at step (308) is followed by assessing if any of the adapters have been designated for a lane downshift (312). More specifically, one or more of the adapters may be designated to decrease the lane allocation that will enable the adapter to efficiently operate and support the associated connector. If any of the adapters are designated for downshifting, a quantity of pre-designated lanes is moved from the associated adapter to one or more adapters that have been designated for a lane upshift (314). As shown, lanes from one or more pre-designated adapters are selectively transferred to one or more adapters pre-designated to receive an additional lane allocation. Following step (314), the process return to step (304) to continue gathering adapter performance data based on the new lane allocation. Accordingly, based on a pre-designated protocol excess lanes from one or more under-utilized adapters may be transferred to one or more over-utilized adapters.

A negative response to the determination at step (312) is an indication that the system is not configured with a pre-designation protocol for an adapter downshift. As such, it is then determined if the system has any under-utilized adapter (316) as ascertained from the statistics collected at step (304). A negative response to the determination at step (316) is followed by a return to step (304). However, a positive response to the determination at step (316) is followed by the system dynamically suggesting one or more adapters for a lane downshift (318) followed by a return to step (304). Accordingly, in the event that the system does not have a pre-designated downshift protocol, the system may dynamically designate an adapter for a lane downshift based on the collected adapter performance data.

As shown in FIGS. 2 and 3, the lane designation and associated assignment to the respective adapters may be subject to change based upon collected performance data. In both of the demonstrated scenarios, excess lanes may be allocated, and adapters may be selectively subject to a lane upshift and a lane downshift.

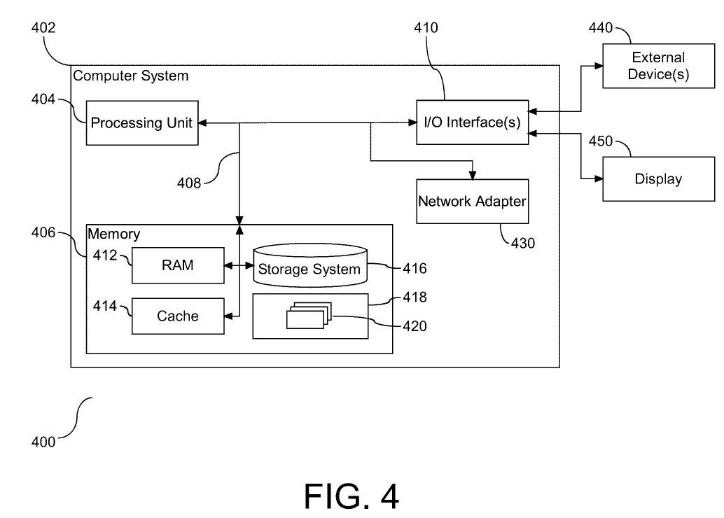

Referring now to FIG. 4, a block diagram (400) is provided illustrating an example of a computer system (402) for implementation of the processes shown in FIGS. 1-3. Computer system/server (402) may be described in the general context of computer system-executable instructions, such as program modules, being executed by a computer system. Generally, program modules may include routines, programs, objects, components, logic, data structures, and so on that perform particular tasks or implement particular abstract data types.

As shown in FIG. 4, computer system/server (402) is shown in the form of a general-purpose computing device. The components of computer system (402) may include, but are not limited to, one or more processors or processing units (404), a system memory (406), and a bus (408) that couples various system components including system memory (406) to processor (404). Bus (408) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Computer system (402) typically includes a variety of computer system readable media. Such media may be any available media that is accessible by computer system (402), and it includes both volatile and non-volatile media, removable and non-removable media.

Memory (406) can include computer system readable media in the form of volatile memory, such as random access memory (RAM) (412) and/or cache memory (414). The system (402) further includes other removable/non-removable, volatile/non-volatile computer system storage media. By way of example only, storage system (416) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus (408) by one or more data media interfaces. As will be further depicted and described below, memory (406) may include at least one program product having a set (e.g., at least one) of program modules that are configured to carry out the functions of the embodiments described above with reference to FIGS. 1-4.

Program/utility (418), having a set (at least one) of program modules (420), may be stored in memory (406) by way of example, and not limitation, as well as an operating system, one or more application programs, other program modules, and program data. Each of the operating systems, one or more application programs, other program modules, and program data or some combination thereof, may include an implementation of a networking environment. Program modules (420) generally carry out the functions and/or methodologies of embodiments as described above with reference to FIGS. 1-3.

The computer system (402) may also communicate with one or more external devices (440), such as a keyboard, a pointing device, a display (440), etc. The external devices (440) may include hardware components that may linked to the processor (404) for transmission and receipt of data via connectors of the I/O interface (410). In one embodiment, I/O interface (410) is a PCI-e computer bus interface. The I/O interface (410) may include a module (not shown) for controlling lane allocation among adapters of the external devices (440) received by the I/O interface (410), as described above with reference to FIGS. 1-3.

The computer system may also communicate with one or more other devices that enable a user to interact with the computer system (402) and/or any devices (e.g., network card, modem, etc.) that enable the computer system (402) to communicate with one or more other computing devices. Still yet, the computer system (302) can communicate with one or more networks such as a local area network (LAN), a general wide area network (WAN), and/or a public network (e.g., the Internet) via network adapter (430). As depicted, network adapter (430) communicates with the other components of the computer system (402) via bus (408). It should be understood that although not shown, other hardware and/or software components could be used in conjunction with the computer system (402). Examples, include, but are not limited to: microcode, device drivers, redundant processing units, external disk drive arrays, RAID systems, tape drives, and data archival storage systems, etc.

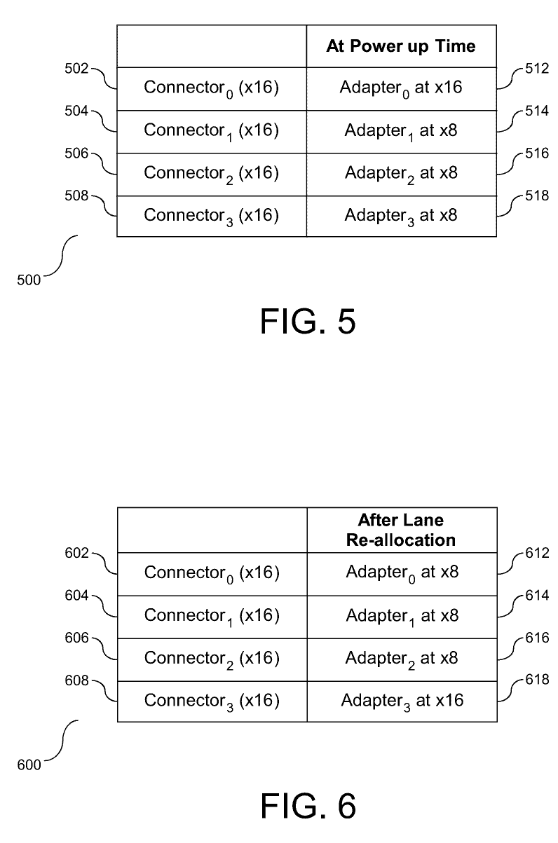

Referring now to FIG. 5, a chart (500) is provided illustrating an allocation of lanes in accordance with an exemplary embodiment. As shown, there are four connectors, Connector₀ (502), Connector₁ (504), Connector₂ (506), and Connector₃ (508), each having a maximum width of sixteen lanes. In this example, at power-up, also known as boot-up, each of the adapters are shown in communication with their respective connectors. The maximum lane allocation is shown in the first adapter Adapter₀ (512), with sixteen lanes allocated. Each of the remaining adapters are shown with an allocation of eight lanes, specifically, Adapter₁ (514), Adapter₂ (516), and Adapter₃ (518) are each shown with an allocation of eight lanes at IPL, _{e.g.} boot-up. Accordingly, at IPL there are forty lanes allocated to Adapters (512)-(516), with a maximum lane allocation to one adapter, and the remaining adapters each have a reduced lane allocation.

In this example, Adapter₀ (512) can perform satisfactorily with eight fewer lanes, and Adapter3 (518) can have improved performance with an increase lane allocation. As shown in FIG. 6, a block diagram (600) of the connector and adapters of FIG. 5 are shown with a dynamic lane re-allocation. More specifically, as shown, there are four connectors, Connector₀ (602), Connector₁ (604), Connector₂ (606), and Connector₃ (608), each having a maximum width of sixteen lanes. The lane allocation is shown following a dynamic re-assignment. Specifically, the first adapter, Adapter₀ (612) has been downshifted to eight lanes, and the fourth adapter, Adapter₃ (618) has been subject to lane upshift to sixteen lanes. The lane allocation to the second and third adapters, Adapter₁ (614) and Adapter₂ (616), respectively, are shown static, _{e.g.} no lane re-allocation. Accordingly, one or more adapters may be dynamically subject to a lane upshift or downshift based on performance data or system configuration.

As will be appreciated by one skilled in the art, the aspects may be embodied as a system, method, or computer program product. Accordingly, the aspects may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, the aspects described herein may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for the embodiments described herein may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The embodiments are described above with reference to flow chart illustrations and/or block diagrams of methods, apparatus (systems), and computer program products. It will be understood that each block of the flow chart illustrations and/or block diagrams, and combinations of blocks in the flow chart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow chart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flow chart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions, which execute on the computer or other programmable apparatus, provide processes for implementing the functions/acts specified in the flow chart and/or block diagram block or blocks.

The flow charts and block diagrams in the Figures illustrate the architecture, functionality, and operation of possible implementations of systems, methods, and computer program products according to various embodiments. In this regard, each block in the flow charts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flow chart illustration(s), and combinations of blocks in the block diagrams and/or flow chart illustration(s), can be implemented by special purpose hardware-based systems that perform the specified functions or acts, or combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The embodiments described herein may be implemented in a system, a method, and/or a computer program product. The computer program product may include a computer readable storage medium (or media) having computer readable program instructions thereon for causing a processor to carry out the embodiments described herein.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmissions, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The embodiments are described herein with reference to flow chart illustrations and/or block diagrams of methods, apparatus (systems), and computer program products. It will be understood that each block of the flow chart illustrations and/or block diagrams, and combinations of blocks in the flow chart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow chart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flow chart and/or block diagram block or blocks.

The corresponding structures, materials, acts, and equivalents of all means or step plus function elements in the claims below are intended to include any structure, material, or act for performing the function in combination with other claimed elements as specifically claimed. The description of the embodiments herein has been presented for purposes of illustration and description, but is not intended to be exhaustive or limited to the embodiments in the forms disclosed. Many modifications and variations will be apparent to those of ordinary skill in the art without departing from the scope and spirit of the embodiments described herein. The embodiments were chosen and described in order to best explain the principles and the practical application, and to enable others of ordinary skill in the art to understand the various embodiments with various modifications as are suited to the particular use contemplated. Accordingly, the implementation of lane allocation to adapters received by connectors of a computer bus shown and described herein provides for a dynamic re-allocation of lanes to adapters following IPL. The re-allocation may be in response to performance data. Similarly, in one embodiment, the re-allocation may be programmed to take place during specific time intervals. Regardless of the protocol employed for the lane re-assignment, the allocation takes place dynamically without requiring system downtime or reboot.

It will be appreciated that, although specific embodiments have been described herein for purposes of illustration, various modifications may be made without departing from the spirit and scope of the specific embodiments described herein. Accordingly, the scope of protection is limited only by the following claims and their equivalents.

1. A system comprising:
a processor in communication with memory;
a module comprising a multiplexer in communication with the processor, and two or more host bridges in communication with the multiplexer; and
a plurality of connectors in communication with respective host bridges, including a first connector in communication with a first host bridge and a second connector in communication with a second host bridge, wherein each host bridge is positioned as an interface between its respective connector and the multiplexer, and wherein each connector is configured to receive a respective adapter, including the first connector in receipt of a first adapter and the second connector in receipt of a second adapter;
the module to:
detect a presence of each adapter, including detection of the first and second adapters;
the multiplexer to allocate system lanes to the detected adapters, including the multiplexer to assign at least one system lane to the first detected adapter and at least one system lane to the second detected adapter;
determine a workload of each detected adapter;
evaluate performance of each detected adapter based on the system lane assignment to each detected adapter and determined workload of each detected adapter;
compare the evaluated performance among detected adapters, including compare an evaluated performance of the first detected adapter to an evaluated performance of the second detected adapter; and
the multiplexer to dynamically re-allocate system lanes between at least two of the detected adapters based on the comparison, including the multiplexer to transfer at least one assigned system lane from the first detected adapter to the second detected adapter.

2. The system of claim 1, wherein the dynamic re-allocation of system lanes comprises the module to balance system lane assignment among the detected adapters, including the module to re-assign system lanes from an over-utilized detected adapter to an under-utilized detected adapter.

3. The system of claim 2, wherein the re-assignment of system lanes to the under-utilized detected adapter is a system lane allocation increase, and wherein the re-assignment of system lanes from the over-utilized detected adapter is a system lane downshift.

4. The system of claim 2, further comprising the module to calculate a first system lane count for the under-utilized detected adapter, the first system lane count including identification of an optimal quantity of system lanes associated with optimal adapter performance and an excess quantity of assigned system lanes greater than the first system lane count.

5. The system of claim 3, further comprising the module to calculate a second system lane count for the over-utilized detected adapter, the second system lane count including identification of a required quantity of system lanes for optimal performance of the over-utilized detected adapter.

6. The system of claim 2, further comprising the module to identify free system lanes, wherein the free system lanes include unassigned system lanes to any of the detected adapters.

7. The system of claim 1, further comprising a tool in communication with the module, the tool to define system lane shifting parameters, and the module to control the dynamic system lane shifting based on the defined parameters.

8. A method comprising:
configuring a computer system with a plurality of connectors in communication with a module, the module comprising a multiplexer in communication with a processor and two or more host bridges in communication with the multiplexer, the host bridges including a first host bridge and a second host bridge, wherein the first host bridge is communication with a first connector and the second host bridge is in communication with a second connector, wherein each host bridge is positioned as an interface between its respective connector and the multiplexer, and wherein each connector is configured to receive a respective adapter, including the first connector in receipt of a first adapter and the second connector in receipt of a second adapter;
detecting, by the module, a presence of each adapter, including detecting the first and the second adapters;
allocating, by the multiplexer, system lanes to each of the detected adapters, including assigning at least one system lane to the first detected adapter and at least one system lane to the second detected adapter;
determining, by the module, a workload of each detected adapter;
evaluating, by the module, performance of each detected adapter based on the system lane assignment to each detected adapter and determined workload of each detected adapter;
comparing, by the module, the evaluated performance among detected adapters, including comparing an evaluated performance of the first detected adapter to an evaluated performance of the second detected adapter; and
the multiplexer dynamically re-allocating system lanes between at least two of the detected adapters based on the comparison, including transferring at least one assigned system lane from the first detected adapter to the second detected adapter.

9. The method of claim 8, further comprising the module balancing system lane assignment among the detected adapters, including re-assigning system lanes from an over-utilized detected adapter to an under-utilized detected adapter.

10. The method of claim 9, wherein the re-assignment of system lanes to the under-utilized detected adapter is a system lane allocation increase, and wherein the re-assignment of system lanes from the over-utilized detected adapter is a system lane downshift.

11. The method of claim 9, further comprising the module calculating a first system lane count for the under-utilized detected adapter, the first system lane count including identification of an optimal quantity of system lanes associated with optimal adapter performance and an excess quantity of assigned system lanes greater than the first system lane count.

12. The method of claim 10, further comprising the module calculating a second system lane count for the over-utilized detected adapter, the second system lane count including identification of a required quantity of system lanes for optimal performance of the over-utilized detected adapter.

13. The method of claim 9, further comprising the module identifying free system lanes, wherein the free system lanes include unassigned system lanes to any of the detected adapters.

14. The method of claim 8, further comprising a tool in communication with the module, the tool defining system lane shifting parameters, and the module controlling the dynamic system lane shifting based on the defined parameters.

15. A computer program product comprising a computer readable hardware storage medium having program code embodied therewith, the program code executable by a processing unit to:
configure a computer system with a plurality of connectors in communication with a module, the module comprising a multiplexer in communication with a processor and two or more host bridges in communication with the multiplexer, the host bridges including a first host bridge and a second host bridge, wherein the first host bridge is communication with a first connector and the second host bridge is in communication with a second connector, wherein each host bridge is positioned as an interface between its respective connector and the multiplexer, and wherein each connector is configured to receive a respective adapter, including the first connector in receipt of a first adapter and the second connector in receipt of a second adapter;
detect a presence of each adapter, including detection of the first and the second detected adapters;
allocate system lanes to the detected adapters, including assign at least one system lane to the first detected adapter and at least one system lane to the second detected adapter;
determine a workload of each detected adapter;
evaluate performance of each detected adapter based on the system lane assignment to each detected adapter and determined workload of each detected adapter;
compare the evaluated performance among detected adapters, including compare an evaluated performance of the first detected adapter to an evaluated performance of the second detected adapter; and
dynamically re-allocate system lanes between at least two of the detected adapters based on the comparison, including to transfer at least one assigned system lane from the first detected adapter to the second detected adapter.

16. The computer program product of claim 15, further comprising program code to:
balance system lane assignment among the detected adapters, including program code to re-assign system lanes from an over-utilized detected adapter to an under-utilized detected adapter; and
calculate a first system lane count for the under-utilized detected adapter, the first system lane count including identification of an optimal quantity of system lanes associated with optimal adapter performance and an excess quantity of assigned system lanes greater than the first system lane count.

17. The computer program product of claim 16, wherein the re-assignment of system lanes to the under-utilized detected adapter is a system lane allocation increase, and wherein the re-assignment of system lanes from the over-utilized detected adapter is a system lane downshift.

18. The computer program product of claim 16, further comprising program code to calculate a second system lane count for the over-utilized detected adapter, the second system lane count including identification of a required quantity of system lanes for optimal performance of the over-utilized detected adapter.

19. The computer program product of claim 16, further comprising program code to identify free system lanes, wherein the free system lanes include unassigned system lanes to any of the detected adapters.

20. The computer program product of claim 15, further comprising program code to define system lane shifting parameters, and control the dynamic system lane shifting based on the defined parameters.
